(19) United States
(12) Patent Application Publication
(10) Pub. No.: US 2025/0167697 A1
(43) Pub. Date: May 22, 2025

(54) MULTI-PHASE POWER CONVERTER CONTROL

(71) Applicant: Siemens Gamesa Renewable Energy A/S, Brande (DK)

(72) Inventors: Paul Godridge, Cheadle, Greater Manchester (GB); Jiajie Luo, Birmingham, West Midlands (GB); Syed Pirzada, London, Greater London (GB); Philip Perry Waite, Maer Hills, Newcastle, Staffordshire (GB)

(21) Appl. No.: 18/842,488

(22) PCT Filed: Feb. 28, 2023
(86) PCT No.: PCT/EP2023/054971

§ 371 Date: Aug. 29, 2024

(30) Foreign Application Priority Data
Mar. 4, 2022 (EP) 22160110.7

(51) Int. Cl. H02M 7/5395; F03D 9/25; G05B 15/02; H02M 1/00; H02M 1/38

(52) U.S. Cl. CPC H02M 7/5395; F03D 9/25; G05B 15/02; H02M 1/0025; F05B 2220/706; H02M 1/38

(57) ABSTRACT

A method of controlling a multi-phase power converter is provided including at least one PWM inverter module for each phase. The method includes (a) receiving a voltage reference value for each phase, (b) checking, for each pair of phases, whether a difference between the corresponding pair of voltage reference values is below a predetermined threshold value, (c) generating a modified reference value for each phase by modifying the received voltage reference values in such a way that the difference between each pair of modified voltage reference values is equal to or larger than the predetermined threshold value, and (d) generating PWM switching signals for the PWM inverter modules based on the modified voltage reference values. Furthermore, a controller for a multi-phase power converter, a computer program, and a wind turbine generator utilizing such a power converter are provided.

### CROSS-REFERENCE TO RELATED APPLICATIONS

This application is a national stage of PCT Application No. PCT/EP2023/054971, having a filing date of Feb. 28, 2023, which claims priority to EP Application No. 22160110.7, having a filing date of Mar. 4, 2022, the entire contents both of which are hereby incorporated by reference.

### FIELD OF TECHNOLOGY

The following relates to the field of multi-phase power converters for electric machines, such as wind turbine generators. The following relates to a method of controlling a multi-phase power converter comprising at least one pulse width modulation (PWM) inverter module for each phase. Furthermore, the following relates to a controller for a multi-phase power converter, a computer program, and a wind turbine generator utilizing such a power converter.

### BACKGROUND

Modern wind turbine generators use multi-phase power converters to generate their output AC power. Such a multi-phase power converter, typically a 3-phase power converter, comprises one or more PWM inverter modules for each phase. It is well known that the switching occurring in such PWM inverter modules may cause various issues, including issues related to EMC (electromagnetic compatibility). Recent investigations have shown that severe EMC related problems may in particular occur when two conditions apply at the same time: (1) current zero crossing of a generator phase, and (2) PWM switching operations taking place at similar times (simultaneous or close to simultaneous) for both the current zero-crossing generator phase and another generator phase.

Hence, there may be a need for a simple and cost-efficient way of avoiding the above-mentioned problems.

### SUMMARY

An aspect relates to a method of controlling a multi-phase power converter comprising at least one PWM inverter module for each phase. In embodiments, the method comprises (a) receiving a voltage reference value for each phase, (b) checking, for each pair of phases, whether a difference between the corresponding pair of voltage reference values is below a predetermined threshold value, (c) generating a modified reference value for each phase by modifying the received voltage reference values in such a way that the difference between each pair of modified voltage reference values is equal to or larger than the predetermined threshold value, and (d) generating PWM switching signals for the PWM inverter modules based on the modified voltage reference values.

This aspect of embodiments of the invention is based on the idea that a minimum proximity of switching in the PWM inverter modules for different phases is obtained by assuring that the reference voltage values relied upon when generating the PWM switching signals differ by at least an amount corresponding to the predetermined threshold value. Thereby, the reference voltages for any two phases will always differ at least by the predetermined threshold value and the corresponding switching in the PWM inverter modules will occur with a corresponding minimum difference in time. This prevents the occurrence of the EMC related issues described above.

According to embodiments of the invention, modifying the received voltage reference values for one pair of phases, for which the difference is below the predetermined threshold value, comprises: (a) calculating a voltage shift value based on the difference and the predetermined threshold value, (b) adding the voltage shift value to the voltage reference value corresponding to one phase of the pair of phases, and (c) subtracting the voltage shift value from the voltage reference value corresponding to the other phase of the pair of phases.

In other words, by adding the voltage shift value to the voltage reference value of one phase and subtracting the voltage shift value from the voltage reference value of the other phase, the overall difference between the respective voltage reference values of the two phases is increased accordingly.

According to an embodiment of the invention, the voltage shift value is added to the largest one of the voltage reference values and subtracted from the smallest one of the voltage reference values.

According to an embodiment of the invention, the voltage shift value is calculated as half the difference between the predetermined threshold value and the difference between the corresponding pair of voltage reference values.

According to embodiments of the invention, the method further comprises (a) receiving a further voltage reference value for each phase, (b) adjusting the further voltage reference value for each phase based on the corresponding voltage shift value, (c) checking, for each pair of phases, whether a further difference between the corresponding pair of adjusted further voltage reference values is below the predetermined threshold value, (d) generating a modified further voltage reference value for each phase by modifying the adjusted further voltage reference values in such a way that the further difference between each pair of modified further voltage reference values is equal to or larger than the predetermined threshold value, and (e) generating further PWM switching signals for the PWM inverter modules based on the modified further voltage reference values.

Here, a set of further voltage reference values is received for the phases, i.e., for the next switching cycle of the PWM inverter modules. The further voltage reference values may differ from the previous voltage reference values, or they may be partially or completely identical to the previous voltage reference values. In any case, the further voltage reference values are adjusted based on the corresponding voltage shift values previously applied to the voltage reference values, i.e., in the previous cycle. If no voltage shift value was applied to one or more phases, the corresponding adjusted further voltage reference values are identical to the respective further voltage reference values. This adjustment provides a feedback feature with the aim of evening out the modifications of the voltage reference values such that the resulting output voltages from the PWM inverter modules do not (over time) deviate significantly from the desired waveforms. The adjusted voltage reference values are then used in the checking and generating steps in the same manner as in the preceding cycle.

According to embodiments of the invention, adjusting the further voltage reference value for each phase comprises (a) subtracting the voltage shift value (i.e., the voltage shift value applied in the preceding cycle) from the further voltage reference value if the voltage shift value was added to the voltage reference value of that phase when modifying the voltage reference values, and (b) adding the voltage shift value (i.e., the voltage shift value applied in the preceding cycle) to the further voltage reference value if the voltage shift value was subtracted from the voltage reference value of that phase when modifying the voltage reference values.

In other words, if the voltage reference for a phase was increased in the preceding cycle, the voltage reference value for that phase will be decreased accordingly in the next cycle, and vice versa.

According to an embodiment of the invention, modifying the adjusted voltage reference values for one pair of phases, for which the further difference is below the predetermined threshold value, comprises (a) calculating a further voltage shift value based on the further difference and the predetermined threshold value, (b) adding the further voltage shift value to the adjusted further voltage reference value corresponding to one phase of the pair of phases, and (c) subtracting the further voltage shift value from the adjusted further voltage reference value corresponding to the other phase of the pair of phases.

In other words, by adding the further voltage shift value to the adjusted further voltage reference value of one phase and subtracting the further voltage shift value from the adjusted further voltage reference value of the other phase, the overall difference between the respective voltage reference values of the two phases is increased accordingly.

According to an embodiment of the invention, the further voltage shift value is added to the largest one of the adjusted further voltage reference values and subtracted from the smallest one of the adjusted further voltage reference values.

According to an embodiment of the invention, the further voltage shift value is calculated as half the difference between the predetermined threshold value and the further difference between the corresponding pair of adjusted further voltage reference values.

According to a second aspect of embodiments of the invention, there is provided a controller for a multi-phase power converter, the multi-phase power converter comprising at least one PWM inverter module for each phase. The controller comprises (a) an input unit configured to receive a voltage reference value for each phase, and (b) a processing unit configured to: (b1) check, for each pair of phases, whether a difference between the corresponding pair of voltage reference values is below a predetermined threshold value, (b2) generate a modified voltage reference value for each phase by modifying the received voltage reference values in such a way that the difference between each pair of modified voltage reference values is equal to or larger than the predetermined threshold value, and (b3) generate PWM switching signals for the PWM inverter modules based on the modified voltage reference values.

This aspect of embodiments of the invention is generally based on the same idea as the first aspect discussed above and essentially provides a controller capable of performing embodiments of the method according to the first aspect.

According to embodiments of the invention, the processing unit is configured to modify the received voltage reference values for one pair of phases, for which the difference is below the predetermined threshold value, by: (a) calculating a voltage shift value based on the difference and the predetermined threshold value, (b) adding the voltage shift value to the voltage reference value corresponding to one phase of the pair of phases, and (c) subtracting the voltage shift value from the voltage reference value corresponding to the other phase of the pair of phases.

In other words, by adding the voltage shift value to the voltage reference value of one phase and subtracting the voltage shift value from the voltage reference value of the other phase, the overall difference between the respective voltage reference values of the two phases is increased accordingly.

The voltage shift value may in particular be added to the largest one of the voltage reference values and subtracted from the smallest one of the voltage reference values.

The voltage shift value may in particular be calculated as half the difference between the predetermined threshold value and the difference between the corresponding pair of voltage reference values.

According to embodiments of the invention, the input unit is configured to receive a further voltage reference value for each phase, and the processing unit is configured to: (a) adjust the further voltage reference value for each phase based on the corresponding voltage shift value (i.e., the voltage shift value applied in the preceding cycle), (b) check, for each pair of phases, whether a further difference between the corresponding pair of adjusted further voltage reference values is below the predetermined threshold value, (c) generate a modified further voltage reference value for each phase by modifying the adjusted further voltage reference values in such a way that the further difference between each pair of modified further voltage reference values is equal to or larger than the predetermined threshold value, and (d) generate further PWM switching signals for the PWM inverter modules based on the modified further voltage reference values.

Here, a set of further voltage reference values is received for the phases, i.e., for the next switching cycle of the PWM inverter modules. The further voltage reference values may differ from the previous voltage reference values, or they may be partially or completely identical to the previous voltage reference values. In any case, the further voltage reference values are adjusted based on the corresponding voltage shift values previously applied to the voltage reference values, i.e., in the previous cycle. If no voltage shift value was applied to one or more phases, the corresponding adjusted further voltage reference values are identical to the respective further voltage reference values. This adjustment provides a feedback feature with the aim of evening out the modifications of the voltage reference values such that the resulting output voltages from the PWM inverter modules do not (over time) deviate significantly from the desired waveforms. The adjusted voltage reference values are then used in the checking and generating steps in the same manner as in the preceding cycle.

According to a third aspect of embodiments of the invention, there is provided a computer program product (non-transitory computer readable storage medium having instructions, which when executed by a processor, perform actions). comprising computer readable instructions, which, when executed by a processor of a computer, in particular a controller for a multi-phase power converter, causes the computer to perform the method according to the first aspect or any of the above embodiments thereof.

This aspect of embodiments of the invention is based on essentially the same idea as the first aspect described above.

According to a fourth aspect of embodiments of the invention, there is provided a wind turbine generator comprising a multi-phase power converter and a controller according to the second aspect described above.

It is noted that embodiments of the invention have been described with reference to different subject matters. In particular, some embodiments have been described with reference to method type claims whereas other embodiments have been described with reference to apparatus type claims. However, a person skilled in the conventional art will gather from the above and the following description that, unless otherwise indicated, in addition to any combination of features belonging to one type of subject matter also any combination of features relating to different subject matters, in particular to combinations of features of the method type claims and features of the apparatus type claims, is part of the disclosure of this document.

The aspects defined above and further aspects of the present invention are apparent from the examples of embodiments to be described hereinafter and are explained with reference to the examples of embodiments. The invention will be described in more detail hereinafter with reference to examples of embodiments. However, it is explicitly noted that the invention is not limited to the described exemplary embodiments.

### BRIEF DESCRIPTION

Some of the embodiments will be described in detail, with references to the following Figures, wherein like designations denote like members, wherein:

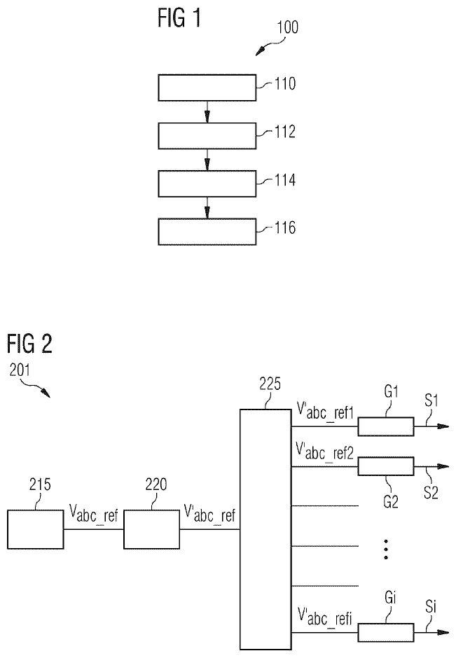

FIG. 1 shows a flow chart of a method of controlling a multi-phase power converter according to an exemplary embodiment of the present invention;

FIG. 2 shows a block diagram of a controller for a multi-phase power converter according to an exemplary embodiment of the present invention;

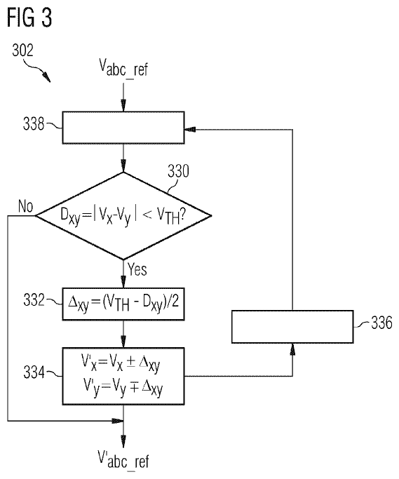

FIG. 3 shows a flow chart of a method of controlling a multi-phase power converter according to a further exemplary embodiment of the present invention;

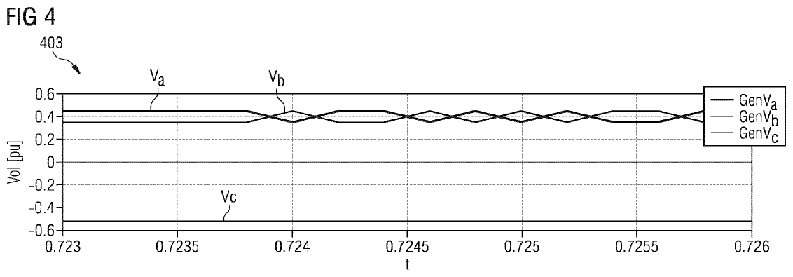

FIG. 4 shows a plot of modified voltage reference values as functions of time in accordance with an exemplary embodiment of the present invention;

FIG. 5 shows a plot of phase voltages and PWM switching signals without utilizing embodiments of the present invention;

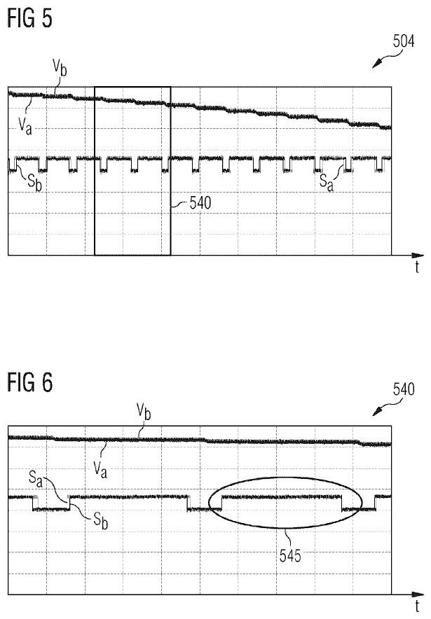

FIG. 6 shows a plot of phase voltages and PWM switching signals without utilizing embodiments of the present invention;

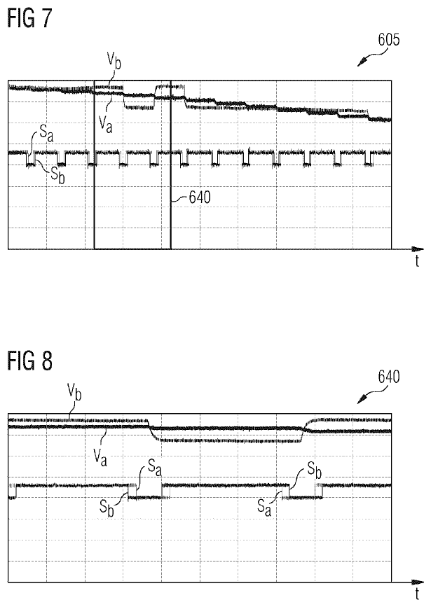

FIG. 7 shows a plot of phase voltages and PWM switching signals when utilizing embodiments of the present invention;

FIG. 8 shows a plot of phase voltages and PWM switching signals when utilizing embodiments of the present invention.

### DETAILED DESCRIPTION

FIG. 1 shows a flow chart 100 of a method of controlling a multi-phase power converter according to an exemplary embodiment of the present invention. The multi-phase power converter comprises at least one PWM inverter module per phase. In embodiments, the method 100 begins at 110 with receiving a voltage reference value for each phase. The voltage reference value indicates the desired output voltage to be generated in order to produce a corresponding output current having a certain waveform. At 112, embodiments of the method continues by checking, for each pair of phases, whether a difference between the corresponding pair of voltage reference values is below a predetermined threshold value. In case the difference is below the predetermined threshold value, at 114, a modified reference value is generated for each phase by modifying the received voltage reference values in such a way that the difference between each pair of modified voltage reference values is equal to or larger than the predetermined threshold value. Finally, at 116, PWM switching signals are generated for the PWM inverter modules based on the modified voltage reference values. In this way, by assuring that the difference between the voltage reference values of any pair of phases is not below the predetermined threshold value, the advantageous effect is obtained that there will be a corresponding minimum time between the switching operations in PWM inverter modules belonging to different phases. Thus, simultaneous (or close to simultaneous switching) in the PWM inverter modules is avoided and so are corresponding EMC related problems.

FIG. 2 shows a block diagram of a controller 201 for a multi-phase power converter according to an exemplary embodiment of the present invention. The controller 201 comprises a current controller 215 configured to provide a voltage reference value V_{a_ref}, V_{b_ref}, V_{c_ref} for each phase in the form of a voltage reference vector V_{abc_ref}, Where a, b and c respectively denotes one of the three phases. The respective voltage reference values in the vector V_{abc_ref} are indicative of the voltages to be output by corresponding PWM inverter modules (not shown). The controller 201 further comprises a functional unit 220 configured to receive the voltage reference values V_{abc_ref}, to check, for each pair of phases, i.e., ab, ac, and bc, whether a difference between the corresponding pair of voltage reference values V_{a_ref}, V_{b_ref}, V_{c_ref} is below a predetermined threshold value, and to generate a modified voltage reference value for each phase by modifying the received voltage reference values in such a way that the difference between each pair of modified voltage reference values is equal to or larger than the predetermined threshold value. The corresponding modified voltage reference vector V′_{abc} is supplied to active current sharing block 225 which calculates corresponding voltage reference vectors V′_{abc_refi} for each of the plurality of PWM inverter modules (not shown) that operate in parallel to generate the desired voltage waveform. Each voltage reference vector V′_{abc_refi} is supplied to a corresponding PWM signal generating unit Gi which generate corresponding PWM switching control signals Si. As shown, the functional unit 220 operates in conjunction with active current sharing block 225, and PWM switching signal generating units G1, G2. . . . Gi to perform the functionality of embodiments of the method 100 discussed above in conjunction with FIG. 1.

FIG. 3 shows a flow chart 302 of a method of controlling a multi-phase power converter according to a further exemplary embodiment of the present invention. In embodiments, the method begins with receiving a voltage reference for each phase, i.e., vector V_{abc_ref}. At 338, an adjustment may be applied to the voltage reference vector V_{abc_ref}—this is described further below. At this stage, at the very beginning of embodiments of the method 302. no adjustment is applied and the voltage reference vector is passed on to 330, where embodiments of the method continues by checking whether a difference between the corresponding voltage reference values D_{xy}=Vₓ−V_{y} for each pair of phases (x and y) is less than a predetermined threshold value V_{TH}. If that is the case, i.e., if D_{xy}<V_{TH}, then a modification or shift value Δ_{xy} is calculated at 332 as Δ_{xy}=(V_{TH}−D_{xy})/2. At 334, modified reference voltage values Vₓ′ and Vₓ′ are calculated by respectively adding and subtracting the shift value Δ_{xy} to the (original) voltage reference values Vₓ and V_{y}. Thereby, the shift value Δ_{xy} is added to the largest of Vₓ and V_{y} and subtracted from the smallest of Vₓ and V_{y}. For those pairs of phases where the check in 330 reveals that the difference is not below the predetermined threshold value, the modification steps 332 and 334 are skipped and no modification is applied. The result is output as a vector V′_{abc_ref} of modified voltage reference values. For those phases where modification is applied. the corresponding shift value Δ_{xy} is fed back at 336. At 338, the feedback shift value Δ_{xy} is used to adjust the subsequently received voltage reference vector V_{abc_ref} for the next PWM switching cycle before performing the steps 330 and, if applicable, 332 and 334. The adjusting in step 338 is done in such a way that if the voltage reference for a phase was increased in the preceding cycle, the voltage reference value for that phase will be decreased accordingly in the next cycle, and vice versa. In other words, if the modification in 334 was V′ₓ=Vₓ+Δ_{xy} and V′_{y}=V_{y}−Δ_{xy}, then the new voltage reference values V_{x_ref} and V_{y_ref} for the corresponding phases x and y will be adjusted as follows (prior to performing the steps 330, 332 and 334): V_{x_ref_adj}=V_{x_ref}−Δ_{xy} and V_{y_ref_adj}=V_{y_ref}+Δ_{xy}. It should be noted that the shift value Δ_{xy} used for the adjusting is the one calculated in the preceding cycle and that a new shift value Δ_{xy} will be calculated and applied to the adjusted voltage reference values in steps 332 and 334. In this way, it is assured that the resulting output voltages from the power converter on average (i.e., over time) will correspond to the intended value while it is at the same time assured that the PWM switching in the inverter modules are sufficiently separated in time such that undesirable EMC related issues do not occur.

FIG. 4 shows a plot 403 of modified voltage reference values Vₐ, V_{b} and V_{c} as functions of time in accordance with an exemplary embodiment of the present invention. More specifically, the plot shows how the two voltages Vₐ and V_{b} are close to each other and take turns being larger/smaller due to the feedback function discussed above in conjunction with FIG. 3. The third phase reference voltage V_{c} remains constant and sufficiently remote from the two other phases during the short period of time shown in plot 403. If one phase were always leading and the other phase were always lagging, the harmonic consequence would be bigger and, more importantly, the amplitude of the fundamental frequency content of the phase voltages would be distorted. With the ‘zigzag’ feature and a relatively large generator inductance value, it has been confirmed by site test that the harmonic distortion is very minor.

FIG. 5 shows a plot 504 of phase voltages Vₐ, V_{b} and PWM switching signals Sₐ, S_{b} without utilizing embodiments of the present invention. More specifically, the plot 504 shows the two-phase voltages Vₐ, V_{b} having a stepwise decreasing and almost coincidental progression. Furthermore, the corresponding PWM switching signals Sₐ, S_{b} are progressing similarly close to each other. FIG. 6 shows a close-up of the window 540. Here, it can in particular be seen that the PWM switching signals Sₐ, S_{b} are practically identical within the highlighted area 545. As discussed elsewhere, such simultaneous switching of the corresponding inverter modules comes with a significant risk of EMC related problems.

FIG. 7 shows a plot 605 of phase voltages Vₐ, V_{b} and PWM switching signals Sₐ, S_{b} when utilizing embodiments of the present invention. Like in FIG. 5, the plot 605 shows the progression of the two-phase voltages Vₐ, V_{b} together with the corresponding PWM switching signals Sₐ, S_{b}. However, different from the progression in FIG. 5, the phase voltage V_{b} is caused to fluctuate around the other phase voltage Vₐ by utilizing embodiments of the present invention as described herein. FIG. 8 shows a close-up of the window 640. Here, it can in particular be seen that the PWM switching signals Sₐ, S_{b} are separated in time such that simultaneous switching of the corresponding inverter modules does not occur.

Generally, the predetermined threshold value V_{TH} is determined to correspond to a certain minimum proximity value, i.e., a certain amount of time that has to be present between PWM switching operations for different phases. In embodiments, it may be advantageous to set the predetermined threshold value V_{TH} to correspond to a time period that is greater than the switching dead time in the PWM inverter modules, as the likelihood of a PWM command becoming corrupted due to a RF event created by another single generator phase would also be reduced.

The embodiments described herein utilize and operate on voltage related modulation signals to control the time difference between the switching edges of the different phases. The skilled person will appreciate that the desired control of the time differences between the switching edges could also be obtained in other ways, for example by utilizing actual voltage signals (as opposed to modulation signals) or time signals. Ultimately it is the time that is decisive for the working principle of embodiments of the present invention, and the skilled person will appreciate that there are several ways of using the relationship between time and a chosen signal to get the desired time difference.

Apart from avoiding the EMC related issues previously discussed, embodiments of the present invention is also beneficial to CMV (common mode voltage) max dV/dt. As two generator phases are not allowed to switch together, a big step of CMV change is divided into two small steps. As a result, dV/dt and voltage overshoot are both reduced, potentially leading to a lower level of generator insulation stress. Besides, it also helps decrease the bearing currents and Equivalent Voltage potentially.

Embodiments of the present invention may in particular be implemented only by making software changes, i.e., without any no hardware expense.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of controlling a multi-phase power converter comprising at least one pulse width modulation (PWM) inverter module for each phase, the method comprising:
receiving a voltage reference value for each phase;
checking, for each pair of phases, whether a difference between the corresponding pair of voltage reference values is below a predetermined threshold value;
generating a modified reference value for each phase by modifying the received voltage reference values in such a way that the difference between each pair of modified voltage reference values is equal to or larger than the predetermined threshold value; and
generating PWM switching signals for the PWM inverter modules based on the modified voltage reference values;
wherein modifying the received voltage reference values for one pair of phases, for which the difference is below the predetermined threshold value, comprises:
calculating a voltage shift value based on the difference and the predetermined threshold value;
adding the voltage shift value to the voltage reference value corresponding to one phase of the pair of phases; and
subtracting the voltage shift value from the voltage reference value corresponding to the other phase of the pair of phases, the method further comprising:
receiving a further voltage reference value for each phase,
adjusting the further voltage reference value for each phase based on the corresponding voltage shift value;
checking, for each pair of phases, whether a further difference between the corresponding pair of adjusted further voltage reference values is below the predetermined threshold value;
generating a modified further voltage reference value for each phase by modifying the adjusted further voltage reference values in such a way that the further difference between each pair of modified further voltage reference values is equal to or larger than the predetermined threshold value; and
generating further PWM switching signals for the PWM inverter modules based on the modified further voltage reference values;
wherein adjusting the further voltage reference value for each phase comprises
subtracting the voltage shift value from the further voltage reference value if the voltage shift value was added to the voltage reference value of that phase when modifying the voltage reference values; and
adding the voltage shift value to the further voltage reference value if the voltage shift value was subtracted from the voltage reference value of that phase when modifying the voltage reference values.

2. The method according to claim 1, wherein the voltage shift value is added to a largest one of the voltage reference values and subtracted from a smallest one of the voltage reference values.

3. The method according to claim 1, wherein the voltage shift value is calculated as half the difference between the predetermined threshold value and the difference between the corresponding pair of voltage reference values.

4. The method according to claim 1, wherein modifying the adjusted voltage reference values for one pair of phases, for which the further difference is below the predetermined threshold value, comprises:
calculating a further voltage shift value based on the further difference and the predetermined threshold values;
adding the further voltage shift value to the adjusted further voltage reference value corresponding to one phase of the pair of phases; and
subtracting the further voltage shift value from the adjusted further voltage reference value corresponding to the other phase of the pair of phases.

5. The method according to claim 4, wherein the further voltage shift value is added to a largest one of the adjusted further voltage reference values and subtracted from a smallest one of the adjusted further voltage reference values.

6. The method according to claim 4, wherein the further voltage shift value is calculated as half the difference between the predetermined threshold value and the further difference between the corresponding pair of adjusted further voltage reference values.

7. A controller for a multi-phase power converter, the multi-phase power converter comprising at least one pulse width modulation (PWM) inverter module for each phase, the controller comprising:
an input unit configured to receive a voltage reference value for each phase, and
a processing unit configured to:
check, for each pair of phases, whether a difference between the corresponding pair of voltage reference values is below a predetermined threshold value,
generate a modified voltage reference value for each phase by modifying the received voltage reference values in such a way that the difference between each pair of modified voltage reference values is equal to or larger than the predetermined threshold value, and
generate PWM switching signals for the PWM inverter modules based on the modified voltage reference values,
wherein the processing unit is configured to modify the received voltage reference values for one pair of phases, for which the difference is below the predetermined threshold value, by:
calculating a voltage shift value based on the difference and the predetermined threshold value,
adding the voltage shift value to the voltage reference value corresponding to one phase of the pair of phases, and
subtracting the voltage shift value from the voltage reference value corresponding to the other phase of the pair of phases,
wherein the input unit is configured to receive a further voltage reference value for each phase, and wherein the processing unit is configured to:
adjust the further voltage reference value for each phase based on the corresponding voltage shift value,
check, for each pair of phases, whether a further difference between the corresponding pair of adjusted further voltage reference values is below the predetermined threshold value,
generate a modified further voltage reference value for each phase by modifying the adjusted further voltage reference values in such a way that the further difference between each pair of modified further voltage reference values is equal to or larger than the predetermined threshold value, and
generate further PWM switching signals for the PWM inverter modules based on the modified further voltage reference values,
wherein the processing unit is configured to adjust the further voltage reference value for each phase by:
subtracting the voltage shift value from the further voltage reference value if the voltage shift value was added to the voltage reference value of that phase when modifying the voltage reference values, and
adding the voltage shift value to the further voltage reference value if the voltage shift value was subtracted from the voltage reference value of that phase when modifying the voltage reference values.

8. A computer program product, comprising a computer readable hardware storage device having computer readable program code stored therein, said program code executable by a processor of a computer system to implement a method according to claim 1.

9. A wind turbine generator comprising a multi-phase power converter and a controller according to claim 7.
